(19) United States
(12) Patent Application Publication
(10) Pub. No.: US 2019/0232465 A1
(43) Pub. Date: Aug. 1, 2019

(54) ASSEMBLING AND TESTING DEVICE AND BRACKET FOR THE SAME

(71) Applicants: BOE Technology Group Co., Ltd., Beijing (CN); K-Tronics (Suzhou) Technology Co., Ltd., Suzhou (CN)

(72) Inventor: Yongchang Wu, Beijing (CN)

(21) Appl. No.: 16/106,312

(22) Filed: Aug. 21, 2018

(30) Foreign Application Priority Data
Jan. 31, 2018 (CN) 201810099463.6

(51) Int. Cl. B25B 11/02

(52) U.S. Cl. CPC B25B 11/02; F16M 11/10

(57) ABSTRACT

An assembling and testing device and a bracket for the same are provided. The assembling and testing device comprises a base plate; and a bracket disposed on the base plate and configured to be in a π form.

### CROSS-REFERENCE TO RELATED APPLICATION

The present application claims the benefit of Chinese Patent Application No. 201810099463.6 filed on Jan. 31, 2018 in the State Intellectual Property Office of China, the whole disclosure of which is incorporated herein by reference.

### FIELD OF THE INVENTION

The present disclosure relates to a display technology, and more specifically, to an assembling and testing device and a bracket for the same.

### DESCRIPTION OF THE RELATED ART

Currently, an assembling and testing device (i.e., assembly line boards) are used when an LCD (liquid crystal display) television product to be tested (for example, to be processed, tested or repaired) needs to be positioned, fixed or held. With the diversification of the LCD television product, especially appearance of curved screen LCD products, it is desirable that the assembling and testing device may be compatible to the display products of different sizes and shapes.

### SUMMARY

According to an aspect of the present disclosure, there is provided an assembling and testing device comprising: a base plate; and a bracket disposed on the base plate and configured to be in a π form.

In an embodiment, a pivoting member is provided on the base plate and the bracket is disposed on the base plate through the pivoting member.

In an embodiment, the bracket comprises: a first vertical rod and a second vertical rod which are connected to the base plate respectively and are spaced apart from each other; and a crossbar disposed on ends of the first vertical rod and the second vertical rod which are away from the base plate, wherein the crossbar is arranged in a π form with the first vertical rod and the second vertical rod.

In an embodiment, the crossbar comprises a protrusion on a first side of the bracket which is in contact with a product to be tested.

In an embodiment, the crossbar comprises a plurality of protrusions which are arranged in an extending direction of the crossbar of the bracket.

In an embodiment, the crossbar comprises a single strip-form protrusion which extends along the entire length of the crossbar.

In an embodiment, the crossbar is fixedly connected to the first vertical rod and the second vertical rod respectively through a fixing member.

In an embodiment, the crossbar is further fixedly connected to the first vertical rod and the second vertical rod through reinforcing members, and the reinforcing members are disposed on one or more sides of the first vertical rod and the crossbar and one or more sides of the second vertical rod and the crossbar.

In an embodiment, the assembling and testing device further comprises an angle adjusting device for adjusting an inclined angle of the bracket, wherein the angle adjusting device is provided on a second side of the bracket which is opposed to a first side of the bracket in contact with a product to be tested.

In an embodiment, the angle adjusting device comprises: a supporting member disposed pivotally on the bracket; and a stopper which cooperates with the supporting member and is disposed on the base plate.

In an embodiment, the stopper comprises at least one slot, and a portion of the supporting member is capable of being received within the at least one slot.

In an embodiment, the supporting member is a U-form inclined supporting rod, and both ends of the U-form inclined supporting rod are respectively disposed at positions below middle of the first vertical rod and the second vertical rod.

In an embodiment, both ends of the supporting member are pivotally connected to the first vertical rod and the second vertical rod through a short pivot shaft respectively.

In an embodiment, the base plate further comprises front limit blocks and rear limit blocks which are configured to limit a front-rear position of a product to be tested and which are disposed on a first side of the bracket in contact with the product to be tested, the front limit blocks and the rear limit blocks are disposed on the base plate by means of holes in the base plate, and positions of the front limit blocks and the rear limit blocks on the base plate are adjusted by inserting the front limit blocks and rear limit blocks into different holes.

In an embodiment, the base plate further comprises left limit blocks and right limit blocks on the base plate which are disposed on left side and right side of the product to be tested and which are disposed on the base plate by means of holes in the base plate, and positions of the left limit blocks and the right limit blocks on the base plate are adjusted by inserting the left limit blocks and the right limit blocks into different holes.

In an embodiment, the base plate further comprises at least one multi-functional limit block disposed on the base plate for limiting a position of a product to be tested, and an arrangement of at least one multi-functional limit block on the base plate is adjusted by inserting the at least one multi-functional limit block into different holes in the base plate.

In an embodiment, the stopper comprises two slot portions and an elastic member mounted on the base plate, and the two slot portions are configured to be symmetrical about the elastic member; and the base plate further comprises a first through-hole below the elastic member on the base plate, through which an ejector pin of a pushing device lifts the elastic member so as to release the engagement of the slots with the supporting member and cause the bracket to switch from an erected state to a folded state on the base plate.

In an embodiment, the stopper comprises two slot portions and an elastic member mounted on the base plate, and the two slot portions are configured to be symmetrical about the elastic member; and the base plate further comprises a second through-hole in the base plate, through which an ejector pin of a pushing device lifts the first vertical rod and the second vertical rod so as to cause the bracket to automatically switch from a folded state to an erected state on the base plate.

According to another aspect of the present disclosure, there is provided a bracket, wherein the bracket is configured generally in a π-form and is disposed on an assembling and testing device.

### BRIEF DESCRIPTION OF THE DRAWINGS

In order to further clarify the technical solutions of the embodiments of the present disclosure, the drawings of the embodiments will be briefly described below. It should be understood that the drawings described below only relate to some embodiments of the present disclosure and do not limit the present disclosure.

FIG. 1 shows schematically a front view of an assembling and testing device according to an embodiment of the present disclosure;

FIG. 2 shows a top view of the assembling and testing device in FIG. 1 in which the bracket is in a folded state; and

FIG. 3 shows schematically a side view of the assembling and testing device according to an embodiment of the present disclosure during a process of testing a LCD television product.

### DETAILED DESCRIPTION OF PREFERRED EMBODIMENTS OF THE INVENTION

In order to illustrate the objects, technical solutions and advantages of the present disclosure more clearly, the embodiments of the present disclosure will be described in detail below with reference to the accompanying drawings. It is to be understood that the following description of the embodiments is intended to illustrate and describe the concept of the present disclosure and should not be considered restrictive. In the specification and the drawings, same or similar reference numerals refer to same or similar components or members. For the sake of clarity, the drawings are not necessarily drawn to scale, and some of the well-known components and structures may be omitted in the drawings.

Unless otherwise defined, technical terms or scientific terms used in the present disclosure are intended to be understood as having the ordinary meaning for those skilled in the art. The words “first”, “second” and the like used in the present disclosure are not intended to indicate any orders, number, or priority, but are used merely to distinguish different components. The word “a” or “an” does not exclude a plurality. The word “comprising” and the like mean that the element or item before the word is intended to encompass the element, the item and the like recited after the word, and not exclude other element or item. The word “connect” and the like are not limited to physical or mechanical connections, but may comprise electrical connections, regardless directly or indirectly. The words “upper”, “lower”, “left”, “right”, “top”, “bottom” and the like are only used to indicate a relative positional relationship. When the position of the described object is changed, the relative positional relationship may be also changed accordingly. When an element, such as a layer, a film, a region or a substrate, is referred to as being “on” or “under” another element, the element may be “on” or “under” another element “directly”, or there may be intermediate elements.

In an assembling and testing device for display products such as LCD televisions or displays, an H-form bracket is used as a main supporting component in the assembling and testing device. However, the H-shaped bracket may be damaged easily, has a poor adaptability, and has difficulty in controlling the position subjected to a force.

Accordingly, one embodiment of the present disclosure provides a bracket for an assembling and testing device as well as an assembling and testing device comprising the same. As an example herein, the assembling and testing device is used for testing the LCD television products. Alternatively, the bracket and the assembling and testing device may also be used for testing similar products such as plasma televisions, OLED televisions and the like, which is not limited in the present disclosure.

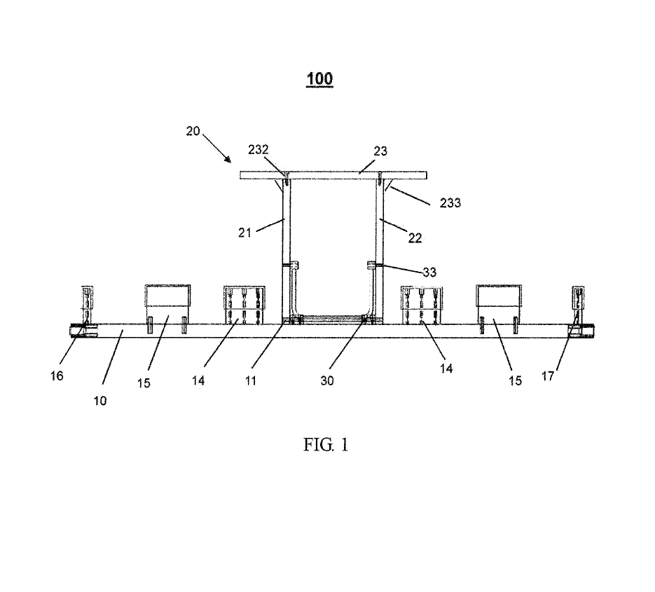

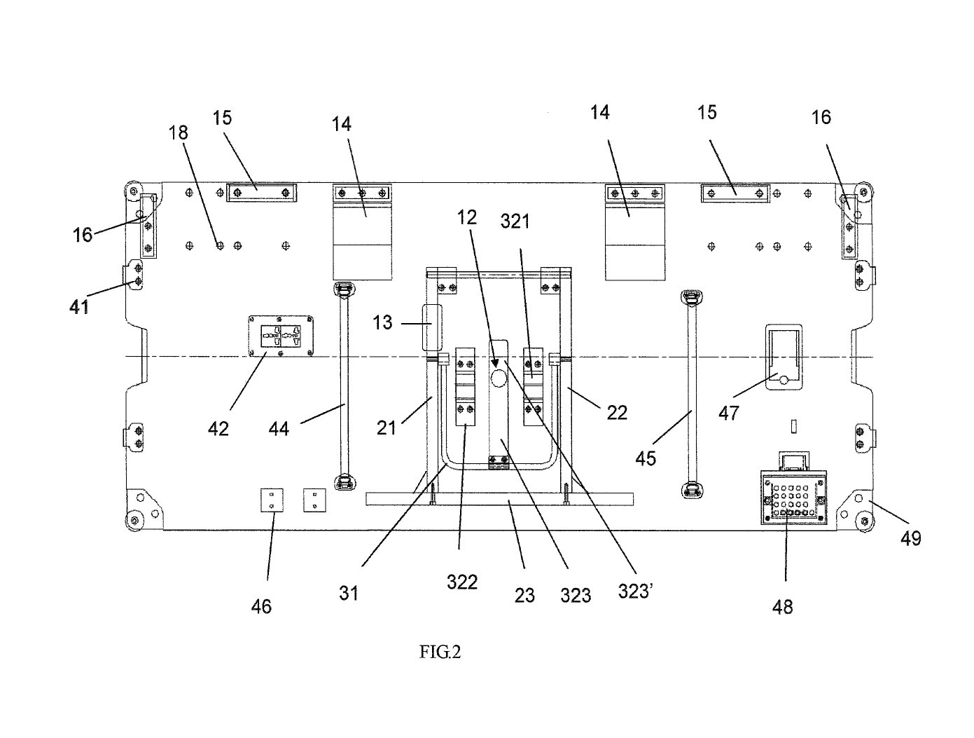

FIG. 1 and FIG. 2 illustrate a front view and a top view of an assembling and testing device according to one embodiment of the present disclosure respectively. As shown in FIG. 1 and FIG. 2, the assembling and testing device 100 includes a base plate 10 and a bracket 20. In one example, the base plate 10 is generally in a rectangular shape. The base plate 10 may be configured by those skilled in the art to have other shape as desired, such as in a square, an ellipse or other irregular shape. The bracket 20 is generally in a π-form and disposed on the base plate 10. The bracket 20 is configured to support the LCD television product during the process of assembling and testing the products such as LCD televisions.

It should be noted that the π-form bracket 20 is not provided with a supporting component, such as a crossbar, in its middle portion. Such an arrangement may facilitate a wire plugging operation at the testing location, since various plug wire port are usually provided in the middle portion of the back of the display product such as a LCD television. When the H-form bracket is employed, it is inevitable to hinder the wire plugging operation at the testing location to some extent due to the crossbar disposed in the middle portion.

In order to make the assembling and testing device 100 more compactable or more space-saving, the bracket 20 may be mounted on the base plate 10 in a foldable manner. For example, the bracket 20 may be pivotally disposed on the base plate 10 through a pivoting member 11 on the base plate 10. The form of the pivoting member 11 is not limited to the specific form shown in FIG. 1. It may also be implemented in other alternative form of pivoting in the art.

Of course, the bracket 20 is not necessarily mounted on the base plate 10 in a foldable manner. It may also be disposed on the base plate 10 through a fixed connection. For example, it is possible to select different specific connection manners according to the material of the bracket 20. When the bracket 20 is made of a material such as plastic, it can be fixedly disposed on the base plate 10 by means of bonding or with screw. When the bracket 20 is made of a material such as metal, it may be connected by welding or the like.

The specific structure of the π-form bracket will be described in detail below. The bracket 20 includes a first vertical rod 21, a second vertical rod 22, and a crossbar 23 connecting the first vertical rod 21 and the second vertical rod 22. As shown in the drawings, the first vertical rod 21 and the second vertical rod 22 are spaced apart from each other and are connected to corresponding pivoting member 11 respectively. The crossbar 23 is disposed on and fixedly connected to the ends of the first vertical rod 21 and the second vertical rod 22 that are away from the base plate 10 respectively. That is, each of the first vertical rod 21 and the second vertical rod 22 is connected to the pivoting member 11 at its one end and connected to the crossbar 23 at the other end. The first and second vertical rod 21, 22 may be connected to the crossbar 23 by means of a fixing member 232 (e.g., a screw) or other connection means known in the art. As shown in FIG. 1, the first and second vertical rod 21, 22 and the crossbar 23 are connected and form a bracket 20 generally arranged in a π-form.

The bracket 20 arranged in a n-shape has advantages of low manufacturing cost and good adaptability in addition to the advantage of the position subjected to the force being located at an upper portion of the bracket. That is, the bracket 20 is not only simple in structure but also suitable for common LCD television products and other specially designed displays.

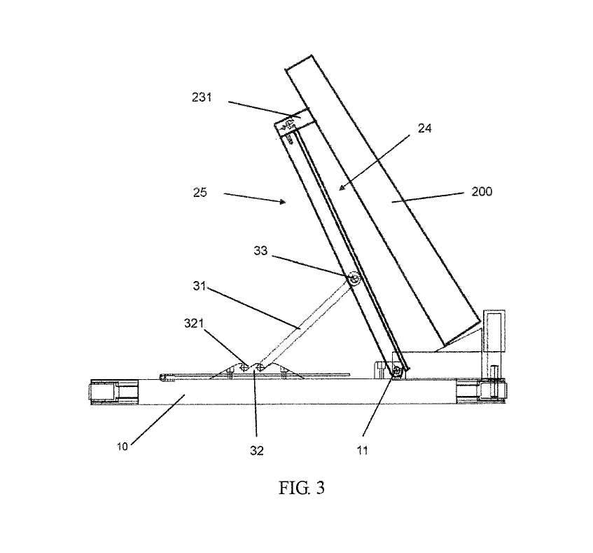

FIG. 3 schematically shows a side view of the assembling and testing device during the process of testing the LCD television product in accordance with one embodiment of the present disclosure. In order to better support and contact the product to be tested or the display product 200 in different shapes, the crossbar 23 may also be provided with a protrusion 231. The protrusion 231 is disposed on a first side 24 of the bracket 20 that is in contact with the product to be tested 200. The crossbar 23 has a convex design, so that the protrusion 231 may be in better contact with the product to be tested of different shapes. Additionally, the point subjected to the force will not be shifted during the test and thus the subjected force is relatively stable.

Compared with the H-form bracket, the point subjected to the force of the π-form bracket is relatively close to the top of the π-form bracket, so that the bracket 20 is lightly forced, may not be easily damaged, and has a relative long service life.

In the embodiment of the present disclosure, the specific shape and arrangement of the protrusion 231 are not limited. For example, in one embodiment, the protrusion may comprise at least one protrusion. The at least one protrusion is discrete and extends at least partially in the extending direction of the crossbar 23. Alternatively, in another embodiment, the protrusion 231 may also be configured as a strip-form protrusion. That is, a single strip-form protrusion extending along the entire length of the crossbar 23. Apparently, in the present disclosure, the protrusion 231 may be configured to have different forms according to specific requirements, and is not limited to the structure illustrated in the drawings. In other words, in the present disclosure, different forms of the protrusion 231 may be employed as long as they may achieve the function of being contact with the product to be tested.

As described above, the crossbar 23 is fixedly connected to the first vertical rod 21 and the second vertical rod 22 through the fixing members 232 respectively. However, it is obvious that the present disclosure is not limited to such a specific connection. In addition, a reinforcing members 233 is arranged on one or more sides of the crossbar 23 and the first vertical rod 21 and fixedly connect the first vertical rod 21 and the crossbar 23, and/or a reinforcing members 233 is arranged on one or more sides of the crossbar 23 and the second vertical rod 22 and fixedly connect the second vertical rod 22 and the crossbar 23. In one embodiment, the reinforcing member 233 may be configured as a L-form reinforcing member, a T-form reinforcing member or other similar form. Position or number of the reinforcing members 233 may be arranged as desired.

As shown in FIGS. 1 and 3, the assembling and testing device 100 is also provided with an angle adjusting device 30 in order to be suitable for the products to be tested of different shapes or sizes and the requirement for a folding design. It should be noted that the angle adjusting device 30 is considered to be a part of the assembling and testing device 100 in the present disclosure. Of course, the angle adjusting device 30 may also be considered as a part of the bracket 20, especially when the bracket 20 is designed to be a foldable and separate product. Of course, the angle adjusting device 30 may also be a separate component and mounted on the assembling and testing device 100, particularly on the bracket 20.

Specifically, on the second side 25 of the bracket 20 that is opposed to the first side 24 which will be in contact with the product to be tested, there is arranged the angle adjusting device 30. The angle adjusting device 30 is used for adjusting the angle of the bracket 20. In particular, the angle adjusting device 30 is arranged to adjust the inclined angle of the bracket 20 with respect to the base plate 10.

It should be noted that the first side 24 of the bracket 20 refers to the side that is in contact with a rear housing of the product to be tested 200 as shown in FIG. 3, and the second side 25 refers to the side opposed to the first side 24.

In one example, the angle adjusting device 30 is configured to adjust the bracket 20 such that the bracket 20 may have 2-3 inclined angles with respect to the base plate 10. Specifically, the angle adjusting device 30 includes a supporting member 31 and a stopper 32. The supporting member 31 is pivotally disposed on the bracket 20, specifically on the second side 25 of the bracket 20. In one example, the supporting member 31 is disposed at a position on the second side 25 that is lower than the middle of the second side 25 of the bracket 20. The stopper 32 is disposed on the base plate 10 and cooperates with the supporting member 31.

Furthermore, at least one slot 321 is disposed on the stopper 32, and the supporting member 31 may be accommodated in the at least one slot 321, thereby fixing and clamping the supporting member 31. As shown in FIG. 3, the stopper 32 is provided with two slots 321. That is, it may adjust the bracket 20 between two inclined angles with respect to the base plate 10. It may be understood that, in order to provide more inclined angles, at least two separate slots 321 may be sequentially disposed on the stopper 32 in a direction perpendicular to an extending direction of the crossbar 23 of the bracket 20. Of course, in the present disclosure, the supporting member is not necessarily fixed by means of a slot. It is possible to employ other feasible alternatives.

As shown in FIG. 1, in the present embodiment, the supporting member 31 is designed to be in a substantially U-form, i.e., an U-form inclined supporting rod. Both ends of the U-form inclined supporting rod are respectively disposed at the positions below the middle of the first vertical rod 21 and the second vertical rod 22. Of course, the joint position of the supporting member 31 with the first vertical rod 21 and the second vertical rod 22 may be set according practice without being limited to the illustrated case.

In one embodiment, both ends of the supporting member 31 are pivotally connected to the first vertical rod 21 and the second vertical rod 22 through a short pivot shaft 33 respectively. Here, by using short pivot shafts, the middle crosspiece of the conventional H-form bracket is omitted, which facilitates the wire plugging operation. In one example, the short pivot shaft 33 may be a short shaft of steel.

In addition, as shown in FIG. 2, the base plate 10 is further provided with a plurality of limit blocks for assisting in positioning the product to be tested 200, a power supply socket, various members for assisting in realizing automatic folding of the bracket 20, and the like.

Specifically, the stopper 32 may be designed to include two slot portions 322 and an elastic member 323 that are mounted on the base plate 10. The two slot portions 322 on the base plate 10 are disposed to be symmetrical about the elastic member 323. Each of the slot portions 322 is provided with at least two slots 321. One end of the elastic member 323 is fixed on the base plate 10 and the other end is a free end. That is, the free end may be warped upward from the base plate. In one example, the present disclosure provides a design concept in which the bracket 20 is switched from an erected state to a folded state by means of an elastic member 323 provided on the base plate 10.

Specifically, a first through-hole 12 is provided in the base plate 10 and below the elastic member 323. The first through-hole 12 is used for lifting the free end 323′ of the elastic member 323 through an ejector pin of the pushing device, thereby lifting the bottom of the U-form inclined supporting rod, and releasing the engagement of the slot 321 with the supporting member 31. As a result, the bracket 20 is switched from the erected state shown in FIG. 3 to the folded state on the base plate 10. As shown in FIG. 2, the first through-hole 12 is designed as a circular hole, although the holes of other shapes are also possible.

In one example, a pushing device with an ejector pin is provided below the base plate 10. For example, by pushing the drive shaft in the pushing device, the ejector pin may automatically pass through the first through-hole 12 and pushing the free end 323′ of the elastic member 323, thereby lifting the free end 323′ of the elastic member 323, and pushing up the bottom of the U-form inclined supporting rod, helping the supporting member 31 to be disengaged from the slot 321. As a result, the bracket 20 is folded and positioned on the base plate 10. That is, the bracket 20 is switched from the erected state to the folded state. In one example, the elastic member 323 may be a galvanized iron sheet.

Furthermore, the present disclosure provides a design concept in which the bracket 20 is switched from a folded state to an erected state.

Specifically, a second through-hole 13 is provided in the base plate 10. The ejector pin of the pushing device automatically passes through the second through-hole 13 and lifts up the first vertical rod 21 and/or the second vertical rod 22 so as to automatically switch the bracket 20 from the folded state to the erected state. For example, when the bracket 20 is folded on the base plate 10, the ejector pin below the base plate 10 is driven to pass through the second through-hole 13 by the drive shaft in the pushing device and lift up the bracket 20 so as to realize the automatic unfolding or erecting of the bracket 20 from the base plate 10. As shown in FIG. 2, the second through-hole 13 is configured as a rectangular hole and located at a position corresponding to the first vertical rod 21. Of course, the position and number of the second through-hole 13 are not limited to the illustrated form and may be set as required.

Automatic folding and unfolding of the bracket 20 may be achieved by providing at least one first through-hole 12 and second through-hole 13 as well as ejector pins that cooperates with them. The embodiments of the present disclosure do not limit the number and position of the first through-hole 12 and the second through-hole 13. Those skilled in the art may freely select their number and set their positions accordingly.

It may be understood that the stopper 32 may also be provided in other forms. For example, only one slot portion 322 is provided without the elastic member 323. Thus, during use, the bracket 20 may be folded or unfolded and be adjusted its angle through manual operations.

When the product to be tested 200 is positioned on the bracket 20, in order to better limit the position of the product to be tested 200, a front stop block 14, a multi-functional stop block 15, and a left and right stop blocks 16, 17 may be disposed on the base plate 10.

As shown in FIG. 2, the front limit block 14 on the base plate 10 is disposed on a side of the base plate 10 that is close to the first side 24 of the bracket 20 (i.e., the left side shown in FIG. 2) and is used for limiting the position of the product to be tested 200 in the front-rear direction. Two symmetrical front limit blocks 14 are shown in FIG. 2. The front limit blocks 14 may be fixedly disposed on the base plate 10. Alternatively, the front limit blocks 14 may be fixedly disposed on the base plate 10 by inserting the front limit block and rear limit block into corresponding holes 18 on the base plate 10. In one example, the front limit block 14 is configured as an L-form limit block.

The left and right limit blocks 16, 17 on the base plate 10 are disposed on the left and right sides of the upper end of the base plate 10 to define the position of the product to be tested 200 in the left-right direction. Also, the left and right limit blocks 16, 17 may be fixedly disposed on the base plate 10. Alternatively, the left and right limit blocks 16, 17 may be fixedly disposed on the base plate 10 by being inserted into corresponding holes 18 on the base plate 10.

In addition, the multi-functional limit block 15 on the base plate 10 is disposed between the front limit block 14 and the left and right limit blocks 16, 17 that are close to the front limit block 14, so that the position of the product to be tested 200 in the left-right or frond-rear direction may be limited by adjusting the arrangement of the multi-functional limit blocks 15 on the base plate 10. In addition, a plurality of holes 18 may be disposed in the base plate 10, and the multi-functional limit blocks 15 may be disposed in different holes 18 to flexibly adjust the arrangement of the multi-functional limiting block 15 on the base plate 10, thereby be more adaptive to the positioning of the product to be tested 200.

At least one buffer limit block 41 may be disposed at edges of the base plate 10 for preventing the assembling and testing device 100 from being damaged due to the colliding with an adjacent assembling and testing device. As shown in FIG. 2, a buffer limit block 41 is disposed on the upper and lower ends of the left and right sides of the assembling and testing device 100 respectively.

In another example, it is also possible to provide a corner-protecting portion 49 at four corners of the assembling and testing device 100 to protect its corners from being damaged and to enhance the strength at the corners of the assembling and testing device 100.

On the base plate 10 there are further provided with a power supply socket 42, a high voltage test interface 46, a video identification card 47, and a wiring port 48. It will be apparent that these components may be arranged as desired and are not limited to the structure illustrated.

In addition, longitudinally extending grooves 44, 45 may be provided on the base plate 10 on left and right sides of the bracket 20 as required, which are used for accommodating cables such as power lines of the product to be tested, avoiding an interference to the test due to the placement of the power lines directly on the base plate 10.

Although the LCD television is used as an example of the product to be tested in the present disclosure, the product to be tested 200 may be any known product with display function such as LCD electronic photo frames, LCD advertising machines, plasma display devices, OLED display devices or the like, in addition to LCD television or LCD display.

Moreover, it should be noted that, for the convenience of description, the bracket 20 and the angle adjusting device 30 in the present disclosure are described as separate components, but it is appreciated that, in order to realize a foldable bracket 20 when it is used as a separate product, it may also include an angle adjusting device 30 in some cases.

As described above, in the above various embodiments of the present disclosure, there is also provided a bracket 20 for assembling and testing device 100. The assembling and testing device 100 is each of the assembling and testing device 100 described above, and the bracket 20 is configured to be in a π form as a whole and disposed pivotally on the assembling and testing device 100. Further, since the specific structural arrangement of the bracket 20 may be the same as that of the brackets in the various embodiments described above, and thus it will not be repeated herein.

The above-described embodiments are merely illustrative of the principles and construction of the present disclosure, and not intended to limit the present disclosure. Those skilled in the art would understand that any modification and improvement to the present disclosure may be made without departing from the general inventive concept. The protection scope of the disclosure should be determined by the scope defined by the claims of the present application.

What is claimed is:

1. An assembling and testing device comprising:
a base plate; and
a bracket disposed on the base plate and configured to be in a π form.

2. The assembling and testing device according to claim 1, wherein a pivoting member is provided on the base plate and the bracket is disposed on the base plate through the pivoting member.

3. The assembling and testing device according to claim 1, wherein the bracket comprises:
a first vertical rod and a second vertical rod which are connected to the base plate respectively and are spaced apart from each other; and
a crossbar disposed on ends of the first vertical rod and the second vertical rod which are away from the base plate,
wherein the crossbar is arranged in a π form with the first vertical rod and the second vertical rod.

4. The assembling and testing device according to claim 3, wherein the crossbar comprises a protrusion on a first side of the bracket which is in contact with a product to be tested.

5. The assembling and testing device according to claim 4, wherein the crossbar comprises a plurality of protrusions which are arranged in an extending direction of the crossbar of the bracket.

6. The assembling and testing device according to claim 4, wherein the crossbar comprises a single strip-form protrusion which extends along the entire length of the crossbar.

7. The assembling and testing device according to claim 4, wherein the crossbar is fixedly connected to the first vertical rod and the second vertical rod respectively through a fixing member.

8. The assembling and testing device according to claim 7, wherein the crossbar is further fixedly connected to the first vertical rod and the second vertical rod through reinforcing members, and the reinforcing members are disposed on one or more sides of the first vertical rod and the crossbar and one or more sides of the second vertical rod and the crossbar.

9. The assembling and testing device according to claim 1, further comprising an angle adjusting device for adjusting an inclined angle of the bracket, wherein the angle adjusting device is provided on a second side of the bracket which is opposed to a first side of the bracket in contact with a product to be tested.

10. The assembling and testing device according to claim 9, wherein the angle adjusting device comprises:
a supporting member disposed pivotally on the bracket; and
a stopper which cooperates with the supporting member and is disposed on the base plate.

11. The assembling and testing device according to claim 10, wherein the stopper comprises at least one slot, and a portion of the supporting member is capable of being received within the at least one slot.

12. The assembling and testing device according to claim 11, wherein the supporting member is a U-form inclined supporting rod, and both ends of the U-form inclined supporting rod are respectively disposed at positions below middle of the first vertical rod and the second vertical rod.

13. The assembling and testing device according to claim 10, wherein both ends of the supporting member are pivotally connected to the first vertical rod and the second vertical rod through a short pivot shaft respectively.

14. The assembling and testing device according to claim 1, wherein the base plate further comprises front limit blocks and rear limit blocks which are configured to limit a front-rear position of a product to be tested and which are disposed on a first side of the bracket in contact with the product to be tested, the front limit blocks and the rear limit blocks are disposed on the base plate by means of holes in the base plate, and positions of the front limit blocks and the rear limit blocks on the base plate are adjusted by inserting the front limit blocks and rear limit blocks into different holes.

15. The assembling and testing device according to claim 14, wherein the base plate further comprises left limit blocks and right limit blocks on the base plate which are disposed on left side and right side of the product to be tested and which are disposed on the base plate by means of holes in the base plate, and positions of the left limit blocks and the right limit blocks on the base plate are adjusted by inserting the left limit blocks and the right limit blocks into different holes.

16. The assembling and testing device according to claim 1, wherein the base plate further comprises at least one multi-functional limit block disposed on the base plate for limiting a position of a product to be tested, and an arrangement of at least one multi-functional limit block on the base plate is adjusted by inserting the at least one multi-functional limit block into different holes in the base plate.

17. The assembling and testing device according to claim 11, wherein the stopper comprises two slot portions and an elastic member mounted on the base plate, and the two slot portions are configured to be symmetrical about the elastic member; and
the base plate further comprises a first through-hole below the elastic member on the base plate, through which an ejector pin of a pushing device lifts the elastic member so as to release the engagement of the slots with the supporting member and cause the bracket to switch from an erected state to a folded state on the base plate.

18. The assembling and testing device according to claim 11, wherein the stopper comprises two slot portions and an elastic member mounted on the base plate, and the two slot portions are configured to be symmetrical about the elastic member; and
the base plate further comprises a second through-hole in the base plate, through which an ejector pin of a pushing device lifts the first vertical rod and the second vertical rod so as to cause the bracket to automatically switch from a folded state to an erected state on the base plate.

19. A bracket, wherein the bracket is configured generally in a π-form and is disposed on an assembling and testing device.
